(19) United States
(12) Patent Application Publication
(10) Pub. No.: US 2015/0278743 A1
(43) Pub. Date: Oct. 1, 2015

(54) Systems and Methods for Assessment of Billing Practices of Medical Provides

(71) Applicant: The Callas Group, LLC, Tustin, CA (US)

(72) Inventor: Constantine Callas, Santa Ana, CA (US)

(73) Assignee: THE CALLAS GROUP, LLC, Tustin, CA (US)

(21) Appl. No.: 14/224,199

(22) Filed: Mar. 25, 2014

(51) Int. Cl. G06Q 10/06; G06Q 50/22

(52) U.S. Cl. CPC G06Q 10/06393; G06Q 50/22

(57) ABSTRACT

Embodiments of the current disclosure provide computerized systems and methods for assessing the billing practices of medical providers, which include steps of: (a) receiving data indicative of a user selection of a medical provider for assessment; (b) accessing from a database statistical data representing, for each of a plurality of potential excess fee categories, a percentage of the selected medical provider's bills that have been determined to be excessive or not excessive in the category; (c) for each category, comparing the percentage against a distribution of percentages from other medical providers to determine a grade value for the selected medical provider in that category; (d) for each category, multiplying the grade factor against a weight factor to produce a category value for that category; (e) summing all of the category values to produce an overall value; and (f) calculating an overall grade for the selected medical provider based upon a ratio of the overall value produced for the selected medical provider versus a maximum overall value available.

### FIELD OF THE INVENTION

The present disclosure relates generally to computer systems and associated methods in the field of managed care, and more particularly, to a computerized medical care system that allows for the assessment and/or grading of the billing practices of medical providers.

### BACKGROUND

There is a need in the managed care field for a system and method that can be used by entities who pay and/or administer medical bills to assess and evaluate which providers practice appropriate billing practices in a particular geographic location. Such entities can include the federal and state governments, insurance companies, third party administrators, managed care organizations, preferred provider organizations (PPO), medical provider networks, and the like.

Such an assessment can be used by administrators of MPN (Medical Provider Networks) to determine which providers may or may not be added and/or renewed to their MPN.

### SUMMARY

Embodiments of the current disclosure provide computerized systems and methods for assessing the billing practices of medical providers. The computerized methods associated with the disclosed embodiments include steps of: (a) receiving data indicative of a user selection of a medical provider for assessment; (b) accessing from a database statistical data representing, for each of a plurality of potential excess fee categories, a percentage of the selected medical provider's bills that have been determined to be excessive or not excessive in the category; (c) for each category, comparing the percentage against a distribution of percentages from other medical providers to determine a grade value for the selected medical provider in that category; (d) for each category, multiplying the grade factor against a weight factor to produce a category value for that category; (e) summing all of the category values to produce an overall value; and (f) calculating an overall grade for the selected medical provider based upon a ratio of the overall value produced for the selected medical provider versus a maximum overall value available.

In a more detailed embodiment the plural of categories may include: (1) infractions of rendering a service that is not medically necessary; (2) infractions of duplicative billing where the medical provider charges for the same service on the same date more than once; (3) infractions of charging for services as a bundle of services where at least a portion of those bundled services are included with in another billed service; (4) infractions of providing a service that is beyond the services normally utilized for the condition being treated; (5) infractions of charging excessive amounts for a service as compared to an amount indicated by a fee schedule for that service; (6) infractions for charging for a service that is inconsistent with methods and rules recommended as appropriate methods of billing as found in industry recognized manuals and fee schedules; and/or (7) infractions for charging for a drug and/or a supply that is inconsistent with an established protocol. In a more detailed embodiment, the plurality of categories may further include: (8) charging for a service to a patient who has already died; (9) charging for a service that was never rendered; (10) charging for a service by a provider's staff who is dead; (11) charging for a service that has not been shown to be safe and/or effective for the condition being treated; and (12) rendering or charging for services in a fraudulent manner.

Alternatively or in addition, each category may have a respective weight factor, and the method may further include a step of receiving the weight factors for each category as selected by a user.

Alternatively or in addition, the distribution of percentages from other medical providers may be based upon a Gaussian distribution, and the grade values may include grade values corresponding to the grades of A, B, C, D and F. For example, the grade value corresponding to the grade of A may be determined when the percentage is in the top 5 to 15% of all providers compared; the grade value corresponding to the grade of B may be determined when the percentages in the next 10 to 30% of all providers compared; the grade value corresponding to the grade of C may be determined when the percentage is in the next 20 to 60% of all providers compared; the grade value corresponding to the grade of D may be determined when the percentage is in the next 10 to 30% of all providers compared; and the grade value corresponding to a grade of F may be determined when the percentage is in the last 5 to 15% of providers compared. In a detailed embodiment, the grade value corresponding to the grade of A may be 4, the grade value corresponding to the grade of B may be 3, the grade value corresponding to the grade of C may be 2, the grade value corresponding to the grade of D may be 1, and the grade value corresponding to the grade of F may be 0. As such, the step of calculating an overall grade value may include a step of multiplying the ratio with the maximum grade value, then a letter grade may be assigned to the selected medical provider based upon where the calculated overall grade value falls on the grade scale.

In an alternate detailed embodiment, the other medical providers used in the comparison may be selected based upon the geographic region of the selected medical provider. Such a geographic region may be a national region, a state region, or may be a local geographic region (for example, comprising one or more local counties).

In yet an alternate detailed embodiment, the method may further include a step of generating a report including the calculated overall grade and electronically delivering the report to a user. The report may include the grade values determined for each category. The report may further include overall grades and categorical grade values for at least two geographical regions; such as, overall grades and categorical grade values for a national region, a statewide region, and/or a local region.

### BRIEF DESCRIPTION OF THE DRAWINGS

In the drawings:

FIG. 1 is a block diagram representation of a computerized medical care system in accordance with an exemplary embodiment of the current disclosure;

FIG. 2 is a screen-shot representation of a provider selection page according to an exemplary embodiment of the current disclosure;

FIG. 3 is a screen-shot representation of a provider information page according to an exemplary embodiment of the current disclosure;

FIG. 4 is a table diagramming grade score calculation steps according to an exemplary embodiment of the current disclosure;

FIG. 5 is a screen-shot representation of a report card presentation screen according to an exemplary embodiment of the current disclosure;

FIG. 6 is a screen-shot representation of a report card print-preview screen according to an exemplary embodiment of the current disclosure; and

FIG. 7 is a flow-chart representation of an exemplary method according to an exemplary embodiment of the current disclosure.

### DETAILED DESCRIPTION

Exemplary embodiments of the current disclosure are directed to providing a computerized system and method for assessing and/or grading the billing practices of medical providers, and providing the results of such assessment to users. Such users may be any party who pays and/or administers medical bills, which can include the federal and state governments, insurance companies, third party administrators, managed care organizations, preferred provider organizations (PPO), medical provider networks and the like.

U.S. Pat. No. 7,979,289, issued Jul. 12, 2011, and entitled “System and Method for Intelligent Management of Medical Care” (the disclosure of the U.S. Pat. No. 7,797,289 is incorporated herein by reference) provides a computerized medical care system in which various embodiments disclosed provide for: validation of a diagnosis of a medical condition, validation of determined medical services, and/or validation of billings or charges for determined medical services. The disclosed medical care system may invoke multiple filters to determine the appropriateness of the diagnosis, medical services, and/or billings/charges. The appropriateness of such items may be based on information gathered from a medical provided, information gathered from experts in the medical field, medical literature, and/or historical data on diagnosis, procedures, billings and the like.

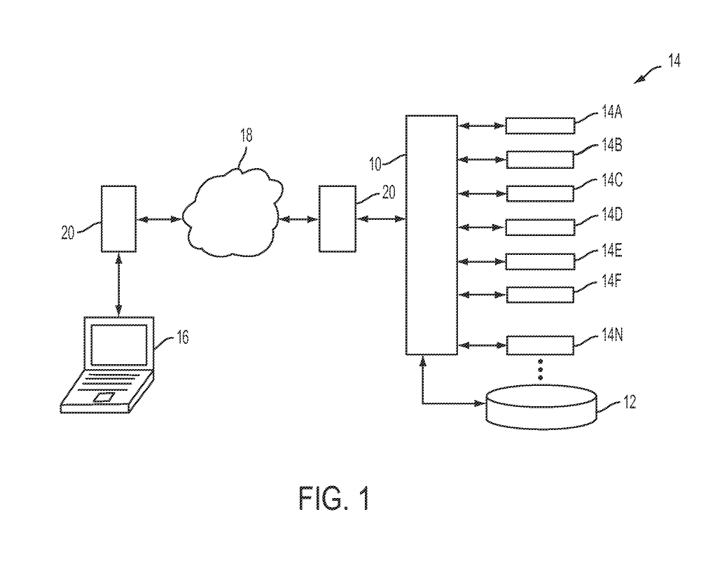

As shown in FIG. 1, an exemplary system according to the current disclosure may include a computer server 10, such as one or more main-frame servers, which may include an artificial intelligence engine.

The server 10 is coupled by a data connection to a database 12 that may include billing data and other offerings from a multitude of medical providers practicing throughout the United States (or any selected geographical region). The server may also include various filters 14 for straining each procedure on each bill for each medical provider to determine whether or not certain charges on each bill are recommended for reduction.

Examples of appropriate filters 14 for determining such reductions or non-reductions may include filters for: (14A) determining infractions of rendering services that are not medically necessary (for example, determining that the service billed is rarely, if ever, performed for the conditions for which the patient is being treated and/or determining that the services are for condition(s) that are not related to the covered injury, illness or diagnosis); (14B) determining infractions for duplicate billing where the provider charges for the same service or same date more than once (for example, determining that the provider has charged again for a procedure for the same date of service on a previous bill and/or determining that the provider charged for duplicate services on the same date on this bill or a previous bill); (14C) determining infractions of charging for services by unbundling, where a portion of those services are included with a service already billed (for example, the value for the procedure billed is included in the value of another procedure performed on the same date and/or a service has been billed that is mutually exclusive of another service or services on the same date); (14D) determining infractions for services that are beyond the services normally utilized for the condition being treated (for example, determining the number of visits is greater than the number of visits which appears reasonable when compared to the number of visits of other patients experience when treated for the same diagnosis or condition and/or determining that the billing for a procedure exceeds a number of treatments that would appear reasonable); (14E) determining infractions of charging an excessive amount for the services compared to an amount indicated by a fee schedule for that service (for example, determining that the charge for a procedure exceeds the amount indicated in the fee schedule); (14F) determining infractions for charging for services that is inconsistent with the methods and rules recommended as appropriate methods of billing found in Medical Fee Schedules and/or Medical Manuals (e.g., Medicaid Manuals, Medicare Manuals, etc.) (for example, determining the procedure or service billed has not been assigned a fee schedule payment amount and/or the procedure requires an invoice that must display the product or equipment); (14G) determining infractions for drugs and/or supplies that are inconsistent with established protocols created to determine reasonableness of charges such as cost-plus rates, dispensing fees, average wholesale price considerations and the like (for example, determining the drug or supply was disallowed according to the fee schedule guidelines and/or determining that the prescription drug dispensed to the patient is not normally prescribed by this type of provider); and (14N) determining infractions for other billing abuses that are logically unreasonable and/or unfair, such as, without limitation, charging for services that are rendered to a patient who is already dead, charging for services that were never rendered, charging for services by provider staff, when the provider is no longer alive, providing for services that have not been proven to be safe and/or effective for the condition being treated, rendering or charging for services in a fraudulent manner.

The above-described filters 14 may be implemented as one or more software modules. The modules may be executed by the server 10 itself, or may be executed by other computers (or computing devices) and/or servers interfacing with the server 10. In this regard, the server 10 or other computing devices executing the artificial intelligence engine may include a processor and a memory. The memory may be a non-transitory memory that stores computer programming instructions that are executed by one or more processors to perform the various computing methods and steps as will be described herein.

The database 12 may also include information used by the filters 14 in determining whether or not billing reductions should be recommended. Such information may include, for example, historical data of the procedures being performed for different diagnoses, historical data surrounding the conditions of rendering the procedures, historical data of charges being applied, and the like. A user 16 utilizing a computing device, such as a laptop computer, desktop computer, handheld computer, smartphone, notepad computer and the like, may access the system via a network connection such as the Internet 18 protected by suitable firewalls 20, which may be interposed between the server 10 and the internet 18 and/or interposed by the user's computing device 16 and the Internet 18.

In an exemplary embodiment, the server 10 provides a web-based graphical-user-interface which may be accessed on the user's computing device 16 utilizing any available web-browsing program or utility available to those of ordinary skill.

An initial login screen may be provided to the user requiring the user to submit appropriate login information for accessing the system (such as username and password).

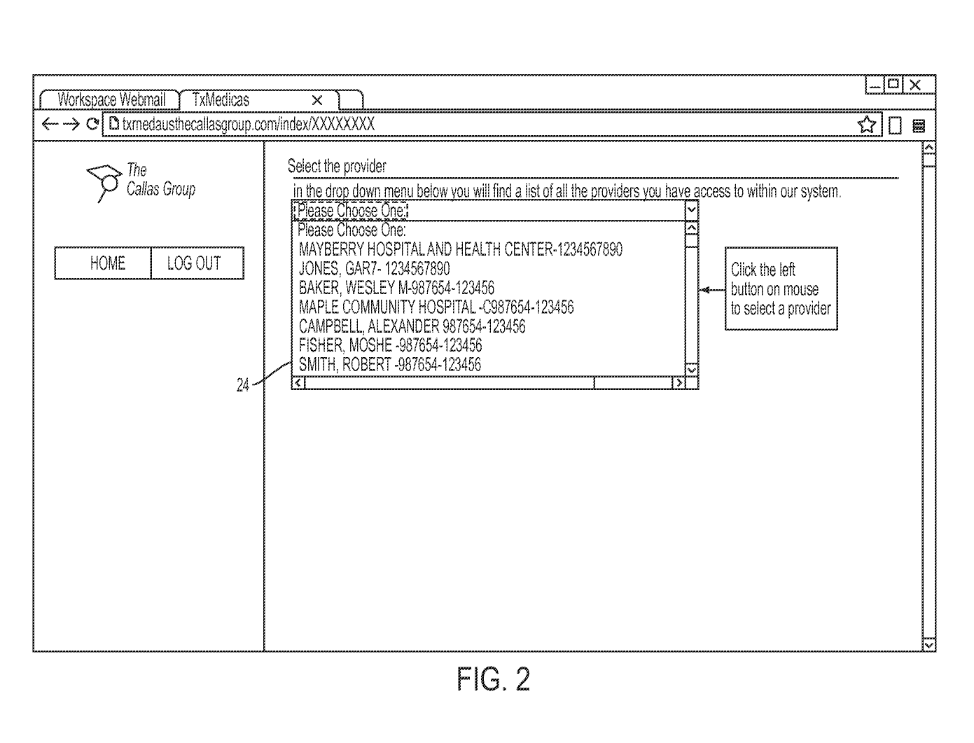

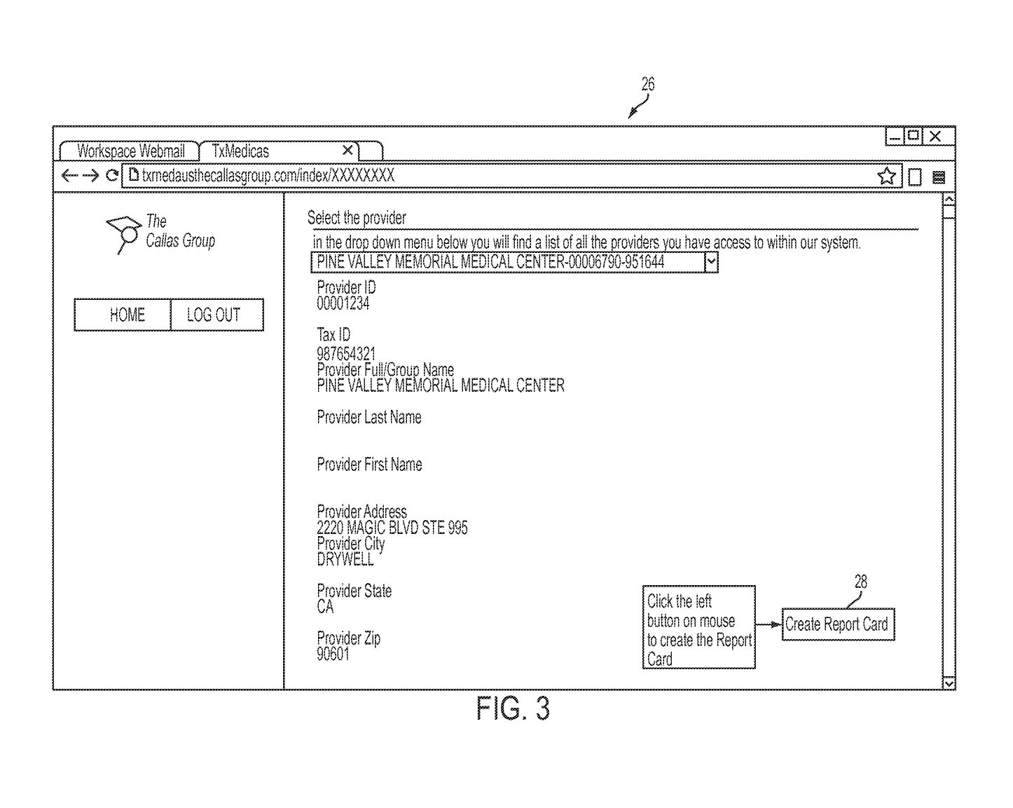

Subsequent to logging on, as shown in FIG. 2, the system may then provide to the user a screen 22 which allows the user, through various search engines or menus, to choose a medical provider for assessment. In the example screen 22 shown in FIG. 2, after a search has been performed, a drop-down menu 24 is provided in which the user can select one of the providers from the list given in the drop-down menu 24. Then, as shown in FIG. 3, the demographic and other information of the selected provider may be given to the user in screen 26 and a button 28 may also be provided in which the user can request the system through the interface to create a report card for the selected medical provider.

Upon receiving a request to create a report card for a selected medical provider, the system will first access from the database 12 statistical data representing, for each of a plurality of potential excess fee categories, a percentage of the selected medical provider's bills that have been determined to be excessive and/or not excessive in the respective category. Example categories may include the following: infractions of rendering a service that is not medically necessary; infractions of duplicate billing where the medical provider charges for the same service on the same date more than once; infractions of charging for services as a bundle of services where at least a portion of those bundled services are included with in another billed service; infractions of providing a service that is beyond the services normally utilized for the condition being treated; infractions of charging excessive amounts for a service as compared to an amount indicated by a fee schedule for that service; infractions for charging for a service that is inconsistent with methods and rules recommended as appropriate methods of billing as found in industry recognized manuals and fee schedules (such as for example, Medicaid Manuals, Fee Schedule Manual, Medicare Manuals and the like); infractions for charging for a drug and/or a supply that is inconsistent with an established protocol; and infractions that are associated with other medical billing abuses.

Examples of other medical billing abuses may include: charging for a service to a patient who has already died; charging for a service that was never rendered; charging for a service by a provider's staff who is dead; charging for a service that has not been shown to be safe and/or effective for the condition being treated; and/or for rendering or charging for services in a fraudulent manner.

Next, the system will, for each category, compare the percentage of the selected medical provider's bills that have been determined to be excessive against a Gaussian distribution of percentages in the same category from a multitude of other medical providers to determine a grade value for the selected medical provider in that category. In the Gaussian distribution, the percentage of excessive billings is placed on the x axis and the number of providers are placed on the y axis. Using this graph, the system is able to determine the grade for each type of excess billing. For example, the following grade scale may be used:

TABLE 1

| Grade | Percentile of Providers |
|---|---|
| A | Top 90 to 100% |
| B | Top 70 to 89.99% |
| C | Middle 20 to 69.99% |
| D | Bottom 10 to 19.99% |
| F | Bottom 0 to 9.99% |

The result of this scaling method is that 10% of the providers will receive an F grade, the next 20% of providers will receive a D grade, the next 40% of providers will receive a C grade, the next 20% of providers will receive a B grade, and the top 10% of providers will received an A grade in the respective excessive billing category. Next, an overall grade is calculated by multiplying each grade value from each excessive billing category by a weighting factor. The grade values for each grade are as follows:

TABLE 2

| Grade | Grade Value |
|---|---|
| A | 4 |
| B | 3 |
| C | 2 |
| D | 1 |
| F | 0 |

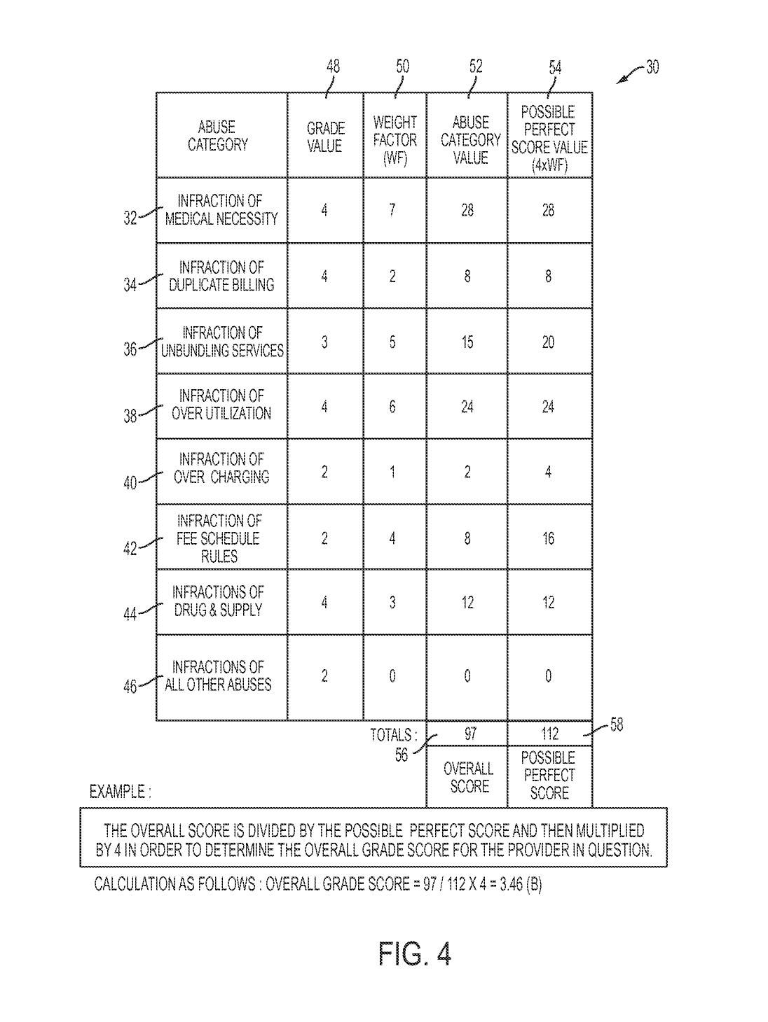

Next, in each excessive billing category, the grade value is multiplied by a weight factor to produce a category value for that category. For example, as shown in FIG. 4, an example grade calculation table 30 is provided. As shown in this table 30, there are eight billing abuse categories: infractions of medical necessity 32, infractions of duplicate billing 34, infractions of unbundling services 36, infractions of over utilization 38, infractions of overcharging 40, infractions of fee schedule rules 42, infractions of drug and supply 44, and infractions of all other abuses 46. In the second column 48, a grade value is determined for each of these categories as described above. As discussed above, a grade value of 4 means that the medical providers receives an A for that category, a grade value of 3 means that the medical provider receives a B for that category, and so on. Then in column 50 a weighting factor is provided for that specific category. The higher the weight, the more importance the particular category is in the overall grade determination. As seen in this example, the weighting factors range from 0 (lowest) to 7 (highest). In the next column 52 the weight is multiplied against the grade value to provide a category value for that category. Then in column 54 the maximum available category value is provided (i.e., the weight applied to a perfect grade of 4). For example, in column 36, “Infraction of Unbundling Services”, the example medical facility received a B, multiplied by a weight factor of 5 giving it a category value of 15 against a maximum category value of 20.

Next, all of the category values are summed to produce an overall value 56. As can be shown in the example of FIG. 4, the sum of overall values is 97, which is compared against a possible perfect score shown in Box 58 of 112.

Finally, an overall grade for the medical provider is calculated by taking a ratio of the overall score 56 against the perfect score 58 and then multiplying that ratio against the maximum grade value (4) to produce an overall grade score. As shown in the example of FIG. 4, the ratio of the overall score (97) divided by the possible perfect score of (112) multiplied by the maximum grade value of (4) equals the overall grade score for this example medical provider of (3.46). When the value of 3.46 is applied to the grade scale as shown in Table 2, the medical provider in this example receives an overall grade of B. Of course, it is within the scope of the current disclosure that pluses and minuses could also be applied to the grades which would result in the current example of the overall grade score of being approximately a B+.

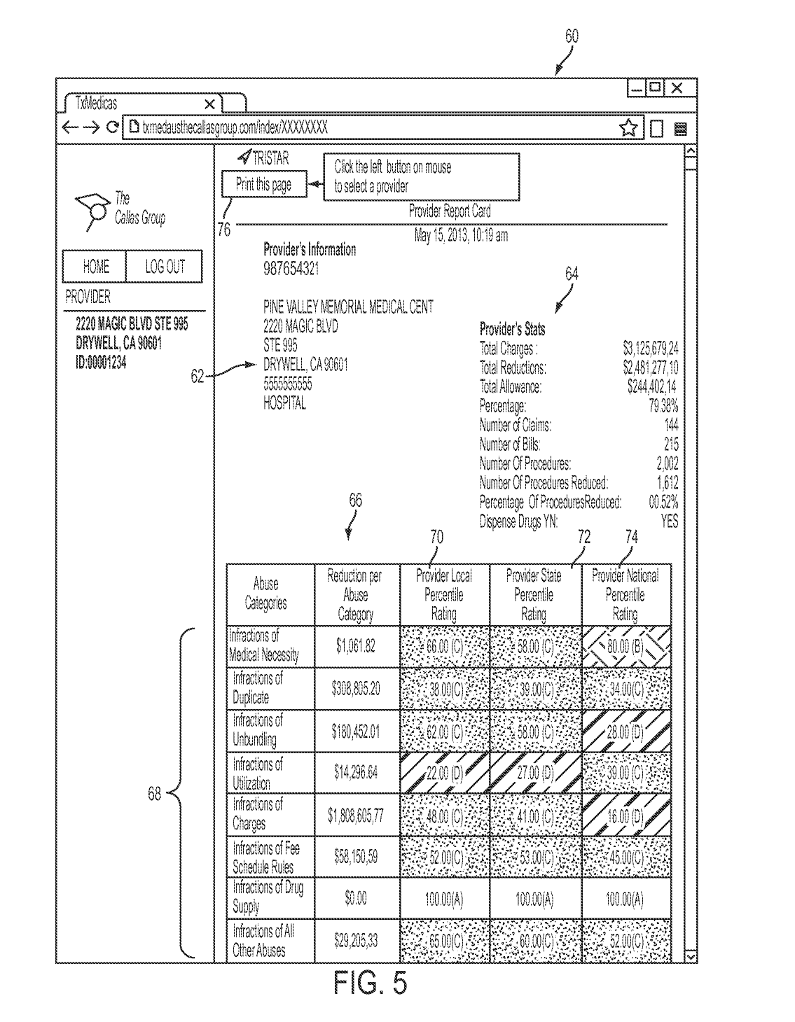

FIG. 5 provides a screen shot example of the “report card” provided for the example medical provider. The screen 60 in this example includes an area that lists the provider information 62, an area that lists provider billing statistics 64 and then a table that provides details of the provider grading calculations. In the table 66 shown in FIG. 5, the example provider is graded for each category 68 in a number of geographical regions. A first column 70 provides the categorical grades for the provider in a local region, in the next column 72 the table provides categorical grades for the provider as compared to the rest of the providers in the state and in column 74 the table provides grades for the current provider against the national geographic region. To calculate the local, state and national ratings, the selection of the other medical provider's percentages in the Gaussian distribution is determined based upon which geographic region is being graded. For example, in the national rating 74 all medical providers in the nation are included in the Gaussian distribution, while in the state grading, only medical providers located in the same state as the selected medical provider are used in the Gaussian distribution.

As also shown in screen 60 on FIG. 5, the user is permitted the opportunity to print the grading report by selecting button 76.

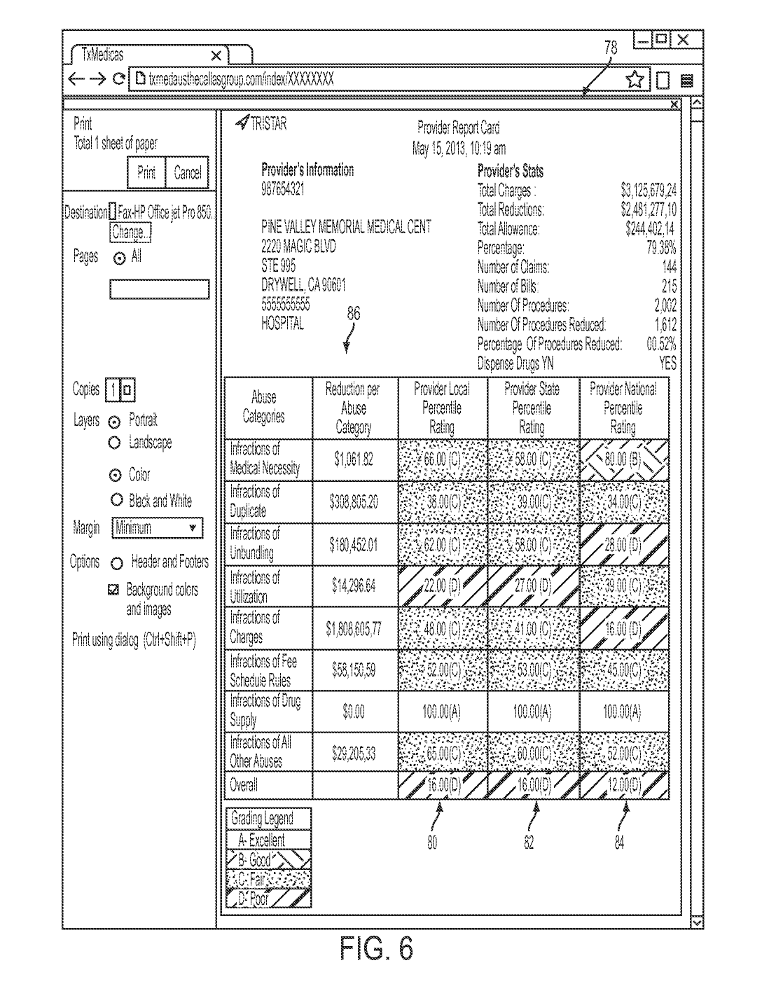

FIG. 6 provides an example printing preview screen 78 which shows an image of the desired printout that includes the information shown from FIG. 5 in a printable format. As shown in the printable format illustrated in FIG. 6, the output table will also include overall grades for the selected medical provider at the local level 80, state level 82, and national level 84. It is also within the scope of the disclosure that the report can include other statistics such as a column 86 listing the total dollars of excessive billing in each category for that selected medical provider.

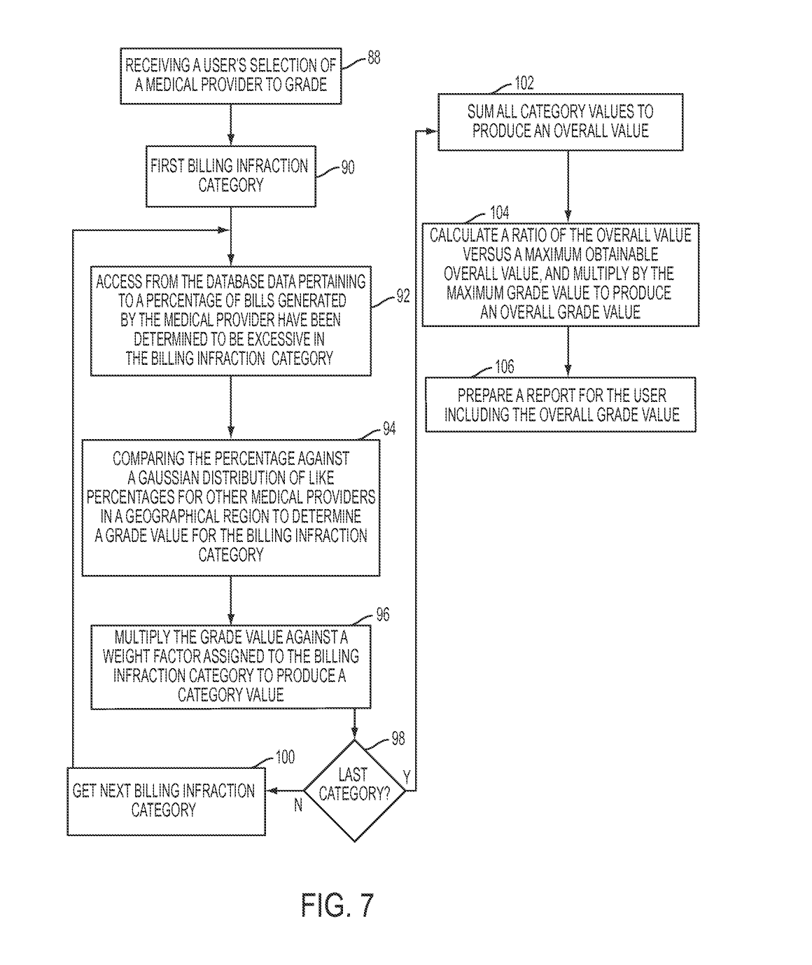

As shown in FIG. 7, an example flow chart representation of a computerized method according to an exemplary embodiment is provided. In a first step 88, the system will receive a user's selection of a medical provider to grade. In the next step 90, a first billing infraction category will be selected. Continuing on to the next step 92, the system will access from the database data pertaining to a percentage of bills generated by the selected medical provider that have been determined to be excessive in the current billing infraction category. Moving on to step 94 the system will compare that percentage against a Gaussian distribution of like percentages for other medical providers in a selected geographical region to determine a grade value for the current billing infraction category. Moving on to the next step 96 the system will then multiply the grade value against a weight factor assigned to the billing infraction category to produce a category value for the current billing infraction category. As shown in step 98, the system will check to see if the current billing infraction category is the last category. If not, the system will advance to step 100 in which a next billing infraction category will be selected and then the process will return to step 92, in which steps 92, 94, 96, 98 and 100 will be repeated until the last category has been processed. If, at step 98, the system determines that the last billing infraction category has been processed, the system will advance to step 102 and will sum all of the category values to produce an overall value. In step 104 the system will calculate a ratio of the overall value versus a maximum attainable overall value and will then multiply that ratio by the maximum grade value to produce an overall grade value. Finally, advancing to step 106, the system will prepare a report that will be electronically transmitted to the user (such as over the internet) that will include at least the overall grade value for the selected medical provider.

In an embodiment, the system may also provide the user with the ability to determine its own weight values for one or more of the various billing infraction categories. That selection may be made, for example, using a pull down menu in a user interface provided by the system over the internet. By providing this capability, the client can weigh the billing abuse categories to suit their own billing philosophies.

It is also within the scope of the current disclosure that multiple medical providers can be collectively graded. For example, rather than a single medical provider being graded, all the medical providers in a particular region can be compiled together in a single grading so that a user can determine the billing practices in a particular region as compared to a larger region. For example, billing practices in a particular county can be compared against billing practices statewide or nationwide. As another example, it is also possible to compare billing practices of medical providers in a given medical practice against other medical practices. In other words, rather than differentiating medical providers or groups of medical providers by regions as described above, the groupings or selections can be differentiated based upon practice fields.

The grade scores described herein can be used by any entity who pays and/or administers medical bills. Such entities can include federal and state governments, insurance companies, third party administrators, managed care organizations, preferred provider organizations (PPO), medical provider networks, and the like. The grade scores can be used to determine which providers should be utilized in their provider networks, how the providers' medical service should be evaluated, which providers to use in a particular geographic location, the overall rating of their provider networks and the like.

It is also contemplated that the grade scores can be used by administrators of medical provider networks (MPN) to determine which providers should or should not be added and/or renewed to their MPN.

The grade scores can also be used by those who administer medical claims to direct a claimant to providers of a specific type and/or specialty who scored above a pre-determined grade threshold in a chosen geographic location.

The grade scores can also be used by those who administer and/or pay medical bills to closely monitor the bill or service authorizations of certain providers who may have scored below a pre-determined grade. Medical providers who score below this threshold may be required, for example, to provide additional documentation before medical service is paid or authorized.

To provide additional context for various aspects of the current disclosure, the following discussion is intended to provide a brief, general description of a suitable computing environment in which the various aspects of the current disclosure may be implemented. While one embodiment of the current disclosure relates to the general context of computer-executable instructions that may run on one or more computers, those skilled in the art will recognize that the embodiments also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the current disclosure may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media (i.e., non-transitory computer readable media) includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the current disclosure may include a computer that includes a processing unit, a system memory and a system bus. The system bus couples system components including, but not limited to, the system memory to the processing unit. The processing unit may be any of various commercially available processors. Dual microprocessors and other multi processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media may provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the current disclosure.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a touch screen display, a keyboard and/or a pointing device, such as a mouse. Other input devices may include a microphone (functioning in association with appropriate language processing/recognition software as known to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

Following from the above description and summaries, it should be apparent to those of ordinary skill in the art that, while the methods and apparatuses herein described constitute exemplary embodiments of the current disclosure, it is to be understood that the inventions contained herein are not limited to the above precise embodiments and that changes may be made without departing from the scope of the inventions. Likewise, it is to be understood that it is not necessary to meet any or all of the identified advantages or objects of the inventions disclosed herein in order to fall within the scope of the inventions, since inherent and/or unforeseen advantages of the current disclosed embodiments may exist even though they may not have been explicitly discussed herein.

What is claimed is:

1. One or more non-transitory computer readable memory devices comprising computer instructions for directing one or more computer processors to perform a method for assessing the billing practices of medical providers, the method including steps of:
receiving data indicative of a user's selection of a medical provider for assessment;
accessing from a database statistical data representing, for each of a plurality of potential excess fee categories, a percentage of the selected medical provider's bills that have been determined to be excessive or not excessive in the category;
for each category, comparing the percentage against a distribution of percentages from other medical providers to determine a grade value for the selected medical provider in that category;
for each category, multiplying the grade value against a weight factor to produce a category value for that category;
summing all of the category values to produce an overall value;
calculating an overall grade for the selected medical provider based upon a ratio of the overall value produced for the selected medical provider versus a maximum overall value available.

2. The one or more non-transitory computer readable memory devices of claim 1, wherein the plurality of categories include:
infractions of rendering a service that is not medically necessary;
infractions of duplicate billing wherein the medical provider charges for the same service on the same date more than once;
infractions of charging for services as a bundle of services wherein at least a portion of those bundled services are included within another billed service;
infractions of providing a service that is beyond the services normally utilized for the condition being treated;
infractions of charging excessive amount for a service as compared to an amount indicated by a fee schedule for that service;
infractions of charging for a service that is inconsistent with methods and rules recommended as appropriate methods of billing as found in industry recognized manuals and fee schedules; and
infractions of charging for at least one of a drug and a supply that is inconsistent with an established protocol.

3. The one or more non-transitory computer readable memory devices of claim 2, wherein the plurality of categories further include one or more of the following:
charging for a service that is rendered to a patient who is already dead;
charging for a service that was never rendered;
charging for a service by a provider staff who is dead;
charging for a service that has not been shown to be safe and/or effective for the condition being treated; and
rendering or charging for services in a fraudulent manner.

4. The one or more non-transitory computer readable memory devices of claim 2, wherein each category has a respective weight factor.

5. The one or more non-transitory computer readable memory devices of claim 4, wherein the method further includes a step of receiving the weight factors for each category as selected by a user.

6. The one or more non-transitory computer readable memory devices of claim 1, wherein the distribution of percentages from other medical providers is a Gaussian distribution.

7. The one or more non-transitory computer readable memory devices of claim 6, wherein the grade values include grade values of corresponding to grades of A, B, C, D and F.

8. The one or more non-transitory computer readable memory devices of claim 6, wherein:
the grade value corresponding to a grade of A will be determined when the percentage is in the top 5 to 15 percent of all providers compared;
the grade value corresponding to a grade of B will be determined when the percentage is in the next 10 to 30 percent of all providers compared;
the grade value corresponding to a grade of C will be determined when the percentage is in the next 20 to 60 percent of all providers compared;
the grade value corresponding to a grade of D will be determined when the percentage is in the next 10 to 30 percent of all providers compared; and
the grade value corresponding to a grade of F will be determined when the percentage is in the last 5 to 15 percent of all providers compared.

9. The one or more non-transitory computer readable memory devices of claim 7, wherein:
the grade value corresponding to the grade of A is 4;
the grade value corresponding to the grade of B is 3;
the grade value corresponding to the grade of C is 2;
the grade value corresponding to the grade of D is 1; and
the grade value corresponding to the grade of F is 0.

10. The one or more non-transitory computer readable memory devices of claim 6, wherein each category has a respective weight factor.

11. The one or more non-transitory computer readable memory devices of claim 9, wherein the method further includes a step of receiving the weight factors for each category as selected by a user.

12. The one or more non-transitory computer readable memory devices of claim 1, wherein the grade value is a numerical value on a grade scale comprising integer numbers, having a maximum grade value corresponding to a grade of A and a minimum grade value corresponding to a grade of F.

13. The one or more non-transitory computer readable memory devices of claim 12, wherein the calculating an overall grade value includes a step of multiplying the ratio with the maximum grade value.

14. The one or more non-transitory computer readable memory devices of claim 13, wherein a letter grade is assigned to the selected medical provider based upon where the calculated overall grade value falls on the grade scale.

15. The one or more non-transitory computer readable memory devices of claim 1, wherein the other medical providers used in the comparison are selected based upon the geographic region of the selected medical provider.

16. The one or more non-transitory computer readable memory devices of claim 15, wherein the geographic region is a national region.

17. The one or more non-transitory computer readable memory devices of claim 15, wherein the geographic region is a state region.

18. The one or more non-transitory computer readable memory devices of claim 15, wherein the geographic region comprises one or more counties.

19. The one or more non-transitory computer readable memory devices of claim 1, wherein the method further comprises a steps of generating a report including the calculated overall grade and electronically delivering the report to a user.

20. The one or more non-transitory computer readable memory devices of claim 19, wherein the report further includes the grade values determined for each category.

21. The one or more non-transitory computer readable memory devices of claim 20, wherein the report further includes overall grades and categorical grade values for at least two geographical regions.

22. The one or more non-transitory computer readable memory devices of claim 21, wherein the at least two geographical regions are taken from a group consisting of a local region, a state-wide region and a national region.

23. The one or more non-transitory computer readable memory devices of claim 1, the plurality of categories include at least four of the following categories:
infractions of rendering a service that is not medically necessary;
infractions of duplicate billing wherein the medical provider charges for the same service on the same date more than once;
infractions of charging for services as a bundle of services wherein at least a portion of those bundled services are included within another billed service;
infractions of providing a service that is beyond the services normally utilized for the condition being treated;
infractions of charging excessive amount for a service as compared to an amount indicated by a fee schedule for that service;
infractions of charging for a service that is inconsistent with methods and rules recommended as appropriate methods of billing as found in industry recognized manuals and fee schedules; and
infractions of charging for at least one of a drug and a supply that is inconsistent with an established protocol.

24. The one or more non-transitory computer readable memory devices of claim 1, the plurality of categories include at least the following categories:
infractions of rendering a service that is not medically necessary;
infractions of duplicate billing wherein the medical provider charges for the same service on the same date more than once;
infractions of charging for services as a bundle of services wherein at least a portion of those bundled services are included within another billed services.

25. The one or more non-transitory computer readable memory devices of claim 1, wherein the user is taken from a group consisting of: a governmental entity, an insurance company, a third party administrator, a managed care organization, an preferred provider organization and a medical provider network.
